(19) United States
(12) Patent Application Publication
(10) Pub. No.: US 2021/0008598 A1
(43) Pub. Date: Jan. 14, 2021

(54) PARCEL SORTING SYSTEM AND METHOD WITH ACTIVE DISPLAY

(71) Applicant: Siemens Logistics LLC, DFW Airport, TX (US)

(72) Inventors: Francisco Grupp, Trophy Club, TX (US); Michael D. Carpenter, Arlington, TX (US)

(21) Appl. No.: 16/504,390

(22) Filed: Jul. 8, 2019

(51) Int. Cl. B07C 3/18; B07C 7/00; B07C 3/20; G09F 13/22

(52) U.S. Cl. CPC B07C 3/18; B07C 7/005; G09F 2013/222; G09F 13/22; B07C 3/20

(57) ABSTRACT

A parcel sorting system and method. A process performed by a parcel sorting system includes receiving sorting information of a first parcel. The process includes determining a sorting destination corresponding to the sorting information. The process includes determining a sorting instruction corresponding to the sorting destination and the first parcel. The process includes transporting the first parcel on a conveying surface. The process includes, while transporting the parcel on the conveying surface, displaying the corresponding sorting instruction on a scrolling marquee display at a location proximate to the first parcel. The process includes, when it is detected that the first parcel has been removed from the conveying surface, the ceasing displaying the corresponding sorting instruction.

### TECHNICAL FIELD

The present disclosure is directed, in general, to parcel processing techniques.

### BACKGROUND OF THE DISCLOSURE

Even in substantially-automated parcel processing, some steps may require manual transfer of parcels into specific destination bins or locations, particularly in the case of irregularly-sized or -shaped parcels. Improved systems are desirable.

### SUMMARY OF THE DISCLOSURE

Various disclosed embodiments include a process performed by a parcel sorting system. A process performed by a parcel sorting system includes receiving sorting information of a first parcel. The process includes determining a sorting destination corresponding to the sorting information. The process includes determining a sorting instruction corresponding to the sorting destination and the first parcel. The process includes transporting the first parcel on a conveying surface. The process includes while transporting the parcel on the conveying surface, displaying the corresponding sorting instruction on a scrolling marquee display at a location proximate to the first parcel. The process includes when it is detected that the first parcel has been removed from the conveying surface, the ceasing displaying the corresponding sorting instruction.

Another disclosed embodiment includes a parcel sorting system comprising a control system, a scrolling marquee display under control of the control system, and a conveying surface under control of the control system, configured to perform processes as described herein.

Various embodiments include, when it is detected that the first parcel has passed the sorting destination and has not been removed from the conveying surface, signaling an exception to an operator. In various embodiments, a sensor is used to detect that the first parcel has been removed from the conveying surface. In various embodiments, a sensor is used to detect that the first parcel has passed the sorting destination. In various embodiments, the location proximate to the first parcel is a location above, below, or otherwise directly associated with the movement of the first parcel on the conveying surface, and the corresponding sorting instruction is scrolled across the scrolling marquee display at substantially a same speed that the first parcel is conveyed on the conveying surface so that the corresponding sorting instruction remains proximate to the first parcel. In various embodiments, the parcel sorting system uses an encoder to determine the speed that the first parcel is conveyed on the conveying surface. In various embodiments, the parcel sorting system uses a plurality of sensors to determine the speed that the first parcel is conveyed on the conveying surface. In various embodiments, the scrolling marquee display is a pixel-based marquee display. In various embodiments, the scrolling marquee display comprises a plurality of individual display units. In various embodiments, receiving sorting information of the first parcel includes using a reader to detect indicia on the first parcel and performing an optical character recognition process or a barcode recognition process on the indicia.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an example of a character set rendered using a pixel matrix;

FIG. 2A illustrates an example of a top view of a sorting system in accordance with disclosed embodiments;

FIG. 2B illustrates an example of a side view of a sorting system. in accordance with disclosed embodiments;

FIG. 3 illustrates a flowchart of a process in accordance with disclosed embodiments; and

FIG. 4 depicts a block diagram of a data processing system with which an embodiment can be implemented.

### DETAILED DESCRIPTION

The figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Parcel delivery services, such as the United Parcel Service, deal with everything that occurs for every item that they deliver between the origination and the destination across the delivery logistic. Within this scope there are typically multiple instances in which sorting occurs at intervals amid transportation steps. In these incremental, repetitive sorting processes, items are grouped according to geographic areas that are progressively smaller, such that in multiple steps, an individual item finds itself comingled with items that share a subsequent transportation step. Ultimately, this process finds its conclusion in a delivery vehicle loaded with items that share a delivery route.

Within this logistic, delivery services handle parcels differently depending on their physical characteristics, including size and weight. Parcels are thereby broken into multiple classes, including “smalls” (items that are smaller than usual), “bigs” (normal-sized items, whose weight does not exceed what can be commonly handled), and “Irregulars,” which constitute anything too ungainly to be processed and transported conventionally, as either a “small” or a “big.” Irregulars represent a major challenge, because other than common means to transport them, typically low speed conveyors or towed carts, they cannot be processed through automation; sorting, loading and unloading are manual exercises.

To sort irregulars manually, the operator is typically required to maintain an association between geographic identifiers, such as address and postal codes, and the particular location (bin) to which items must be sorted. In addition, it is necessary for the operator to be able to see the label on each item (recognition) to be able to identify the delivery address. Since irregulars are ungainly, reorientation of an irreg to be able to see the label can be a difficult process. Similarly, manipulating irregulars to separate them from comingled, unsorted items to the sorting bin of items grouped according to geographical area (sortation), is difficult and slow. Both recognition and sortation are expensive, and are plagued by errors, which add even more cost.

One practice is to utilize low-speed conveyors and towed carts to move irregulars between the steps of unloading, moving, sorting, moving and loading. The rest of the steps are based on an operator manually lifting and moving the irregulars. Even the process of performing address/destination recognition of printed indicia on the parcel can require manual intervention; where a system may use a handheld or “ring” scanner to read the parcel, this often requires the operator to manipulate the parcel to scan the label, which in turn reduces the productivity during sorting. Once the destination is known by the operator, the operator must then have memorized associations between the destination address or facility and the sorting positions on the sorting systems.

The need for operator memorization can be addressed by using automation to communicate parcel-specific information to a user. For example, U.S. Pat. No. 7,063,256, incorporated herein by reference, describes an item tracking and processing system that includes a see-through display worn by a user (e.g., glasses or goggles) that is used to display “characteristic information” about items as they are being tracked through a processing system. As another example, U.S. Pat. No. 8,825,200, incorporated herein by reference, describes a method and system for tracking of items that includes projecting an image onto an item on a conveyor that includes human-readable instructions for disposition of the item. These and other patents illustrate that basic parcel-tracking and destination processing techniques are well known to those of skill in the art, and so are not discussed in detail herein.

Automatic tracking systems are designed to maintain association between singulated (single file) items being conveyed over a distance, and information regarding those items. This allows for a processing system to accumulate information regarding items being conveyed as they are conveyed, and to process each item uniquely according to the accumulated information. For example, items being conveyed can be weighed in motion, barcode information can be read from each item in motion, and then weight and barcode information accumulated for each item can be used to sort items according to destination, while keeping all items weighing over a certain threshold separate. The information pertaining to items being conveyed and tracked is available at every point in the journey on the conveyor.

Automatic sorting systems are designed to sort from a conveying means based on information derived from the items being sorted. This is typically a postal code that is either associated with a barcode or encoded into it. The automatic sorting system is able to lookup a physical destination along the conveying means that is associated with a postal code, so that sortation to the destination associated with that code, supported by the automatic tracking system, occurs at the exact point in distance, and the item being sorted is automatically separated from the conveying means at that point.

Disclosed embodiments improve the sorting operation by communicating sorting information to the sorting operator without requiring complex wearable-display systems or projecting information on a moving parcel. Disclosed embodiments eliminate the need for the sorting operator to memorize associations between destination address information and sorting positions while providing fast, efficient, and effective instructions for the operator.

Disclosed embodiments include automatic tracking and automatic sorting techniques in a system in which an operator is responsible to remove an item being sorted from the conveying means to a destination at a precise point, as directed by a scrolling marquee, which is synchronized with an automatic tracking system.

Disclosed embodiments include one or more displays that extend along the length of a conveyor from which items are sorted to destinations adjacent to the conveyor. For ease of discussion herein, references to a single display will be used, but those of skill in the art will recognize that the display can be implemented using multiple display units. The display may be mounted above or below the conveying surface.

In some embodiments, the display is implemented as pixel-based sign, such as a scrolling marquee-style display. A scrolling marquee represents a matrix of pixels with an aspect ratio that is typically wider than it is tall. The height of the matrix is sufficient to render at least one character in dot matrix form, with each pixel representing one dot. The width is typically sufficient to render words or even phrases of words composed of dot matrix characters.

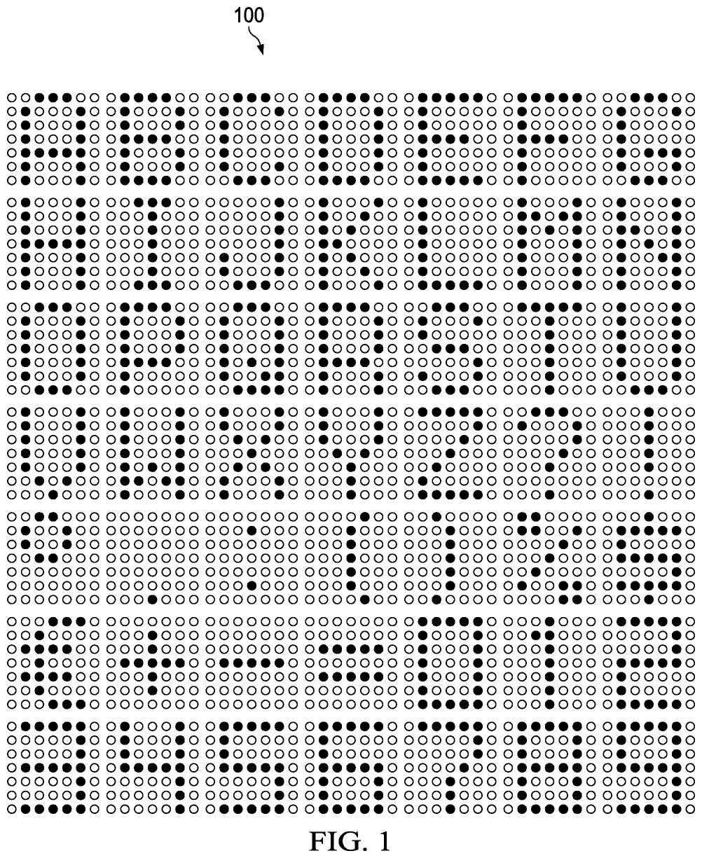

FIG. 1 illustrates an example of a character set 100 rendered using a pixel matrix. As illustrated in this example, a matrix of dots as few as seven pixels high and seven pixels wide provides sufficient resolution to render a single character and a space. A scrolling marquee may render a message composed of dot matrix characters in a lighted matrix that is much wider than the message requires. The pattern of dots (of which the message is composed) is subsequently, synchronously, and continuously shifted across the wide matrix to the right or left at a rate that gives the impression of the message being in motion. The rate of the shift is adjustable.

The “scrolling marquee display” refers to any display as described herein, where sorting instructions or other information is displayed and “scrolled” across the display to remain proximate to corresponding parcels. While a pixel-based marquee display is used in specific embodiments, other embodiments can use other display technologies, such as LCD, LED, OLED, and others. Regardless of the technology used to implement the display, the display or combination of display units together implement the scrolling marquee display as described herein with respect to disclosed embodiments.

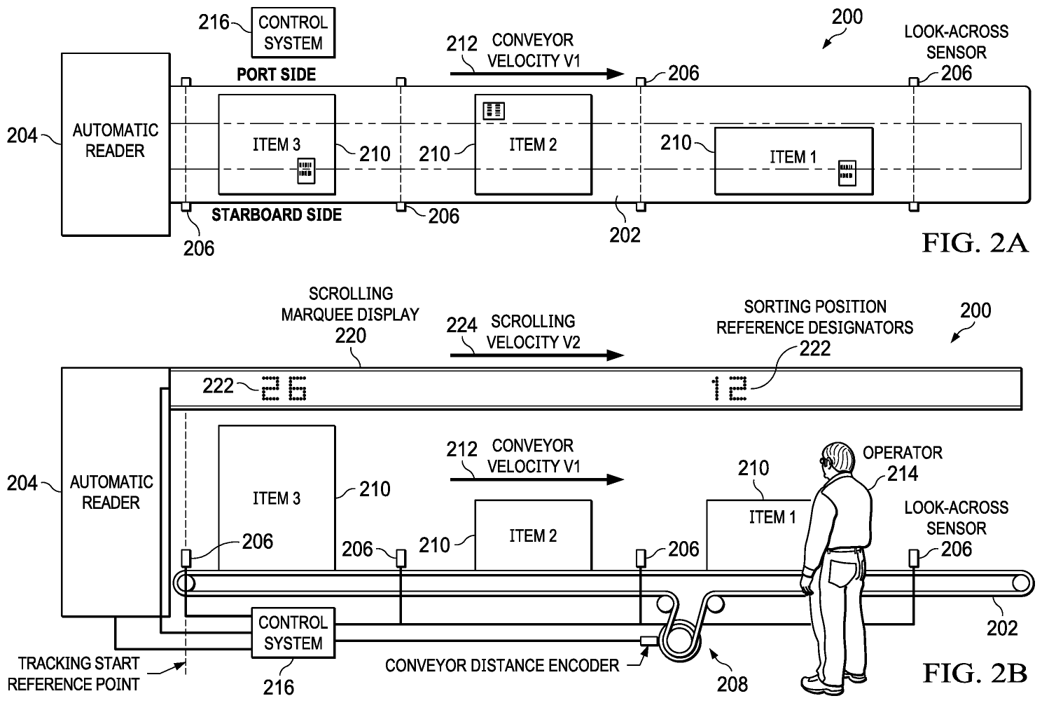

FIG. 2A illustrates an example of a top view of a sorting system 200 in accordance with disclosed embodiments, while FIG. 2B illustrates an example of a side view of sorting system 200. As illustrated in FIG. 2A, a conveying surface 202 transports a series of parcels 210 through or past a reader 204 and then continues to transport them at a conveying velocity V1 as indicated at 212. Conveying surface 202 can be implemented using any conveying technology, including belts, rollers, and others, or combinations of these, and in this example is shown as a conveyor belt.

Along conveying surface 202 are a plurality of sorting destinations (not shown) to which the parcels 210 are to be moved by operator 214. Automatic parcel reader 204 determines the sorting destinations of parcels 210 to which each parcel should be moved from sorting system 200. The parcel reader 204 can detect indicia on each parcel and can perform an optical character recognition process on the indicia, perform a barcode recognition process on the indicia, and otherwise determine the sorting destination from the parcel 210. As part of this step, the reader 204 or sorting system 200 can also determine physical characteristics of each parcel 210, such as dimensions and weight. The information for each of the parcels 210 can be looked-up by control system 216 to correlate a physical destination along the conveying surface 202 for each parcel 210.

The parcel reader 204 and other components of sorting system 216 are under the control of control system 216 shown in FIG. 2B. Control system 216 can be located at or remote from the remainder of sorting system 200 and can be dedicated to sorting system 200 or also control other processing equipment.

One or more sensors 206 are used to detect the presence and location of each of the parcels 210. Sensors 206 can be implemented as look-across sensors, pressure sensors, vision sensors, physical switches, sonic or other proximity sensors, or otherwise.

FIG. 2B illustrates these same elements, and in particular shows that sensors 206 and conveying surface 202 are connected to be controlled by control system 216. In some embodiments, control system 216 also communicates with conveyor distance encoder 208, which can detect the travel distance and speed of conveying surface 202 when conveyor belts are used. Of course, in other embodiments, control system 216 can use any technology known to those of skill in the art to monitor and control the speed and transport distances of conveying surface 202. As illustrated in FIG. 2B, a first sensor 206 after the parcel reader 204 can be used as a tracking start reference point when tracking each parcel 210 on the conveying surface 202.

Sorting system 200 can track parcels 210 using sensors 206. For example, control system 216 can measure the distance traveled by each parcel 210 from a known reference point, such as a first sensor 206 (measuring the absolute distance), or from a previous reference point (measuring relative distance), or both. Distance can be measured by a conveyor distance encoder 208, which provides a signal whose frequency precisely matches the actual speed of the conveyor (conveying velocity V1). In other embodiments, sorting system 200 may track parcels 210 by measuring time rather than distance, which may be less accurate than distance measurement techniques.

As each parcel 210 passes the automatic reader 204, control system 216 or automatic reader 204 can derive sorting information and other information that is relevant to the sorting destination for each parcel 210 from labels and other markings on each parcel. The control system 216 can then automatically track each parcel 210, such as from automatic reader 204 or from another known reference point. Control system 216 can maintain information from the automatic reader for each parcel 210 in a table that correlates the information from each item with a predetermined sorting destination for each item, including a sorting instruction 222, such as sorting position reference designator.

The sorting instruction 222 for each item can be communicated from the control system 216 to the scrolling marquee display 220, along with a synchronization signal to control scrolling velocity V2. In pixel-matrix embodiments, as each item on the conveyor moves in distance equivalent to one horizontal pitch of the dot matrix, the sorting instruction 222 is shifted one pitch. The sorting instruction 222 is maintained directly above or below each of the items on the conveyor, and sorting instruction 222 is moved in synchronization with the items on the conveyor.

FIG. 2B illustrates the scrolling marquee display 220 in accordance with disclosed embodiments. Scrolling marquee display 220 displays a sequence of sorting instructions 222 that scroll along scrolling marquee display 220 at a scrolling velocity V2 as shown at 224. According to disclosed embodiments, control system 216 identifies and maintains a correspondence between each parcel 202, its sorting destination, and the sorting instruction 222 that indicates the corresponding sorting destination. For example, in FIG. 2, the parcel 202 labeled “Item 1” has a sorting instruction 222 of “12,” indicating that the operator 212 should move that parcel from the conveying surface 202 to the sorting destination numbered 12. Similarly, the parcel 202 labeled “Item 3” has a sorting instruction 222 of “26,” indicating that the operator 212 should move that parcel from the conveying surface 202 to the sorting destination numbered 26.

As is clear from this illustration, the display 220 provides an easy and intuitive direction for the operator 214 as to where he is to move each parcel. By scrolling the sorting instructions 222 (moving at scrolling velocity V2) at the same speed as the parcels 210 are being conveyed on conveying surface 202 (moving at conveyor velocity V1), the sorting instruction 222 stays visually associated with its corresponding parcel 202 until that parcel is moved. In this example, the sorting instruction is a number indicating a sorting destination, but of course other identifiers could be used, such as letters, colors, other symbols, or otherwise.

The scrolling marquee display 220 can be mounted above and in line with the conveying surface 202, or below and in line with the conveying surface 202, but in either case, it preferably extends as long as the portion of the conveying surface 202 from which manual sorting will occur. The control system 216 controls display 220 based on the conveyor velocity V2 to synchronize the scroll rate of the scrolling marquee display 220 to scrolling velocity V2, and to shift sorting instruction 222 in the same direction as the conveyor's direction of travel.

As parcels 210 are being conveyed by conveying surface 202, the sorting instruction 222 relative to each parcel 210 is scrolled on display 222 along with the parcel 210 being conveyed, preferably in the same place, in the same direction, and at the same speed.

When each parcel 210 being conveyed is nearing its own destination along the conveying surface 202, the sorting instruction 222 on the display 220 can begin to flash, change color, or otherwise indicate that action is required by the operator.

When the parcel 210 has been removed the operator 214 to its destination point, it will no longer be detected by sensors 207, and the sorting instruction 222 for that parcel 210 is removed from the scrolling marquee display 220. In the example of FIG. 2B, the operator 214 is in the process of moving the parcel 210 labeled “item 1” from the conveying surface 202 to sorting destination “12.” Once “item 1” is removed from the conveying surface 202, when the conveying surface 202 has moved a sufficient distance so that the next downstream sensor 206 should have become blocked or otherwise detected the presence of “item 1,” but does not (because the item is not present), the sorting instruction 222 is removed from the scrolling marquee display 220.

At the end of the conveying surface 202 there may be an accumulation point. Parcels 210 that have not been sorted to their destinations, for example if the operator 214 was not able to timely remove them from the conveying surface 202, can continue to an ending accumulation point, such as at the end of conveying surface 202, and the sorting instruction 222 for that parcel 210 may be retained in the display 220 above or below the position of the parcel 210.

During commissioning of a sorting system 200, the distances between the tracking start reference point and each sorting destination can be loaded into the control system 216, along with the sorting position reference designations for each sorting destination. This allows the control system 216 to continuously calculate the distance to the destination for each item being conveyed.

In some embodiments can include sorting destinations on both sides of the conveying surface 202. In these configurations, operators may be required to work on both sides of the conveyor, and a scrolling marquee display 220 as described herein can be implemented facing each side to display sorting instructions for the items, so that there is a separate display 220 on each side of the conveyor. In these double-sided configurations, control system 216 can also track the side of the conveyor surface 202 associated with each destination, so that interleaved items being sorted to alternate sides have sorting instruction 222 displayed only on the display 220 on the side of conveying surface 202 to which they will ultimately be sorted. For example, in FIG. 2B, the parcel 210 labeled “Item 2” is to be sorted to a sorting destination on the other side of the conveying surface 202, so its sorting instruction 222 is not displayed on the display 220 (and not shown in this single-side view), but would be displayed on a display 220 on the opposite side of conveying surface 202.

In various embodiments, sorting system 200, under control of control system 216, can identify and signal sorting exceptions. For example, when an item is removed before having reached the sorting destination, the subsequent downstream sensors 206 are not blocked at the appropriate point, which is indicative of mis-sorting having occurred. As another example, when an item is not removed at its prescribed sorting destination, sensors 206 downstream of the sorting destination can detect the parcel as still being present when it should not be, which is indicative of a sorting failure. In any exception case, the sorting system 200 can visually or audibly signal the exception.

Sorting system 200 can take various actions, in various embodiments, when sorting exceptions have taken place. For example, control system 216 can stop the conveyor when a sorting exception has occurred, so that the error can be corrected. Some embodiments can include a holding position at the end of the conveyor that allows for certain sorting exceptions (such as items not corresponding to any destination, or sorting failures) to be held stationary after having not been sorted, and for the related sorting instruction 222 to be maintained stationary at that position.

Systems and methods as disclosed herein provide significant advantages in productivity and accuracy over other parcel processing systems. According to disclosed embodiments, destinations are indicated in the proximity of relevant items being transported, which increases accuracy and efficiency in manual-handling steps, and in particular provides significant improvement in the processing of irregulars.

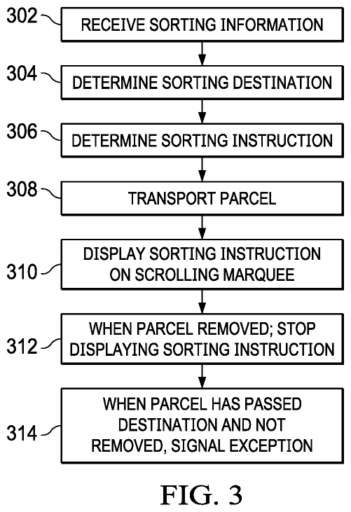

FIG. 3 illustrates a flowchart of a process 300 in accordance with disclosed embodiments. The process of FIG. 3 can be implemented by using any of the features, components, or devices discussed herein, or any combination of them. The process of FIG. 3 is performed, for example, by a parcel sorting system as disclosed herein, and under the control of its control system.

The sorting system receives sorting information for a first parcel (302). The sorting information can include such information as a delivery destination, whether an ultimate delivery destination, a regional processing center, or other information by which the first parcel is sorted from other parcels. “Receiving” data, as used herein, can include loading from storage, receiving from another device or process, or otherwise. In specific embodiments, however, the parcel sorting system receives the sorting information by using a reader 204 to detect indicia on the first parcel and can include performing an optical character recognition process on the indicia, performing a barcode recognition process on the indicia, and otherwise. As part of this step, the reader 204 or parcel sorting system 200 can also determine physical characteristics of the first parcel 220A, such as dimensions and weight.

The parcel sorting system determines a sorting destination corresponding to the sorting information (304). The sorting destination can be a bin, chute, pallet, cart, or other physical destination into or onto which the parcel is to be placed by an operator.

The parcel sorting system determines a sorting instruction corresponding to the sorting destination and the first parcel (306). The sorting instruction can be, for example, a number, letter, or other symbol or combination of symbols that indicates the sorting destination to an operator.

The parcel sorting system transports the first parcel on a conveying surface (308).

While the parcel sorting system is transporting the first parcel on the conveying surface, the parcel sorting system displays the corresponding sorting instruction on a scrolling marquee display at a location proximate to the first parcel (310). As described herein, the sorting instruction is displayed at a location above, below, or otherwise directly associated with the movement of the first parcel on the conveying surface, and is scrolled across the display at substantially the same speed as the first parcel is conveyed on the conveying surface so that the sorting instruction remains proximate to the first parcel. This can include displaying the corresponding sorting instruction as flashing or in a different color when the first parcel nears the sorting destination.

When the parcel sorting system detects that the first parcel has been removed from the conveying surface, the parcel sorting system ceases displaying the corresponding sorting instruction (312).

When the parcel sorting system detects that the first parcel has passed the sorting destination and has not been removed from the conveying surface, the parcel sorting system signals an exception to an operator (314).

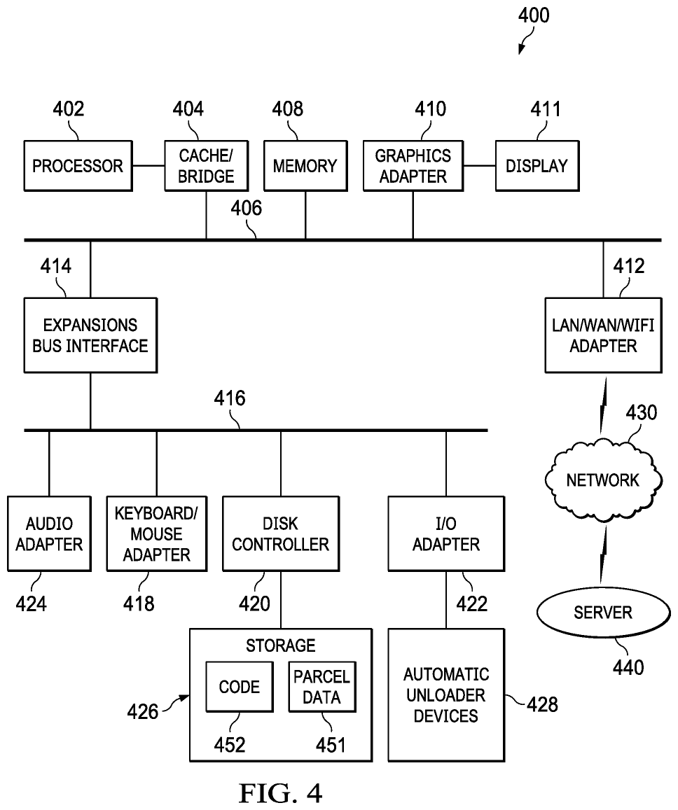

FIG. 4 depicts a block diagram of a data processing system 400 in which an embodiment can be implemented, for example as a control system for parcel sorting system as described herein and can be configured to perform processes as described herein, such as in control system 216. The data processing system depicted includes a processor 402 connected to a level two cache/bridge 404, which is connected in turn to a local system bus 406. Local system bus 406 may be, for example, a peripheral component interconnect (PCI) architecture bus. Also connected to local system bus in the depicted example are a main memory 408 and a graphics adapter 410. The graphics adapter 410 may be connected to display 411. Display 411 can be, in various embodiments, any display or combination of displays as described herein to produce the scrolling marquee display on one or both sides of a conveying surface.

Other peripherals, such as local area network (LAN)/Wide Area Network/Wireless (e.g. WiFi) adapter 412, may also be connected to local system bus 406. Expansion bus interface 414 connects local system bus 406 to input/output (I/O) bus 416. I/O bus 416 is connected to keyboard/mouse adapter 418, disk controller 420, and I/O adapter 422. Disk controller 420 can be connected to a storage 426, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Storage 426 can store any data and code useful for performing processes as described herein. For example, storage 426 can store parcel data 451, which can include any parcel data, parcel information, address and destination data, sorting instructions, sorting data, associations between parcels, destinations, instructions, and other elements, user inputs, device commands, or other data used for the monitoring and control of the parcel sorting system. Storage 426 can also store, as another example, executable code 452 that, when executed, causes processes as described herein to be performed.

I/O adapter 422 can be connected to parcel processing devices 428, as described herein, to which can include any hardware elements used to perform processes in accordance with the various embodiments described herein, including but not limited to sensors, readers, conveyors, user input devices, display devices, indicators, conveyors, transporters, robots, parcel transport and management systems, etc.

Also connected to I/O bus 416 in the example shown is audio adapter 424, to which speakers (not shown) may be connected for playing sounds. Keyboard/mouse adapter 418 provides a connection for a pointing device (not shown), such as a mouse, trackball, trackpointer, etc.

Those of ordinary skill in the art will appreciate that the hardware depicted in FIG. 4 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 412 can be connected to a network 430 (not a part of data processing system 400), which can be any public or private data processing system network or combination of networks, as known to those of skill in the art, including the Internet. LAN/WAN/Wireless adapter 412 can also communicate with other devices or systems as described herein or as known for use in parcel processing or monitoring, and perform other data processing system or server processes described herein. Data processing system 400 can communicate over network 430 with one or more server systems 440, which are also not part of data processing system 400, but can be implemented, for example, as separate data processing systems 400. A server system 440 can be, for example, a central server or facility management system at a processing facility.

The exemplary data processing system 400 can also be used to implement an operator console or facility management system as described herein.

Those skilled in the art will recognize that, for simplicity and clarity, the full structure and operation of all systems suitable for use with the present disclosure is not being depicted or described herein. Instead, only so much of the physical systems as is unique to the present disclosure or necessary for an understanding of the present disclosure is depicted and described. The remainder of the construction and operation of the systems disclosed herein may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs). In particular, computer readable mediums can include transitory and non-transitory mediums, unless otherwise limited in the claims appended hereto.

Although an exemplary embodiment of the present disclosure has been described in detail, those skilled in the art will understand that various changes, substitutions, variations, and improvements disclosed herein may be made without departing from the spirit and scope of the disclosure in its broadest form. In particular, the features and operations of various examples described herein can be combined in any number of implementations.

None of the description in the present application should be read as implying that any particular element, step, or function is an essential element which must be included in the claim scope: the scope of patented subject matter is defined only by the allowed claims. Moreover, none of these claims are intended to invoke 35 USC § 112(f) unless the exact words “means for” are followed by a participle.

What is claimed is:

1. A method performed by a parcel sorter system, comprising:
receiving sorting information of a first parcel;
determining a sorting destination corresponding to the sorting information;
determining a sorting instruction corresponding to the sorting destination and the first parcel;
transporting the first parcel on a conveying surface;
while transporting the first parcel on the conveying surface, displaying the corresponding sorting instruction on a scrolling marquee display at a location proximate to the first parcel; and
when it is detected that the first parcel has been removed from the conveying surface, the ceasing displaying the corresponding sorting instruction.

2. The method of claim 1, further comprising, when it is detected that the first parcel has passed the sorting destination and has not been removed from the conveying surface, signaling an exception to an operator.

3. The method of claim 2, wherein a sensor is used to detect that the first parcel has been removed from the conveying surface.

4. The method of claim 1, wherein a sensor is used to detect that the first parcel has passed the sorting destination.

5. The method of claim 1, wherein the location proximate to the first parcel is a location above, below, or otherwise directly associated with the movement of the first parcel on the conveying surface, and the corresponding sorting instruction is scrolled across the scrolling marquee display at substantially a same speed that the first parcel is conveyed on the conveying surface so that the corresponding sorting instruction remains proximate to the first parcel.

6. The method of claim 5, wherein the parcel sorting system uses an encoder to determine the speed that the first parcel is conveyed on the conveying surface.

7. The method of claim 5, wherein the parcel sorting system uses a plurality of sensors to determine the speed that the first parcel is conveyed on the conveying surface.

8. The method of claim 1, wherein the scrolling marquee display is a pixel-based marquee display.

9. The method of claim 1, wherein the scrolling marquee display comprises a plurality of individual display units.

10. The method of claim 1, wherein receiving sorting information of the first parcel includes using a reader to detect indicia on the first parcel and performing an optical character recognition process or a barcode recognition process on the indicia.

11. A parcel sorting system, comprising:
a control system;
a scrolling marquee display under control of the control system; and
a conveying surface under control of the control system,
wherein the parcel sorting system is configured to:
receive sorting information of a first parcel;
determine a sorting destination corresponding to the sorting information;
determine a sorting instruction corresponding to the sorting destination and the first parcel;
transport the first parcel on a conveying surface;
while transporting the parcel on the conveying surface, displaying the corresponding sorting instruction on a scrolling marquee display at a location proximate to the first parcel; and
when it is detected that the first parcel has been removed from the conveying surface, the cease displaying the corresponding sorting instruction.

12. The parcel sorting system of claim 11, wherein the parcel sorting system is further configured to, when it is detected that the first parcel has passed the sorting destination and has not been removed from the conveying surface, signaling an exception to an operator.

13. The parcel sorting system of claim 12, further comprising at least one sensor that is used to detect that the first parcel has been removed from the conveying surface.

14. The parcel sorting system of claim 11, further comprising at least one sensor that is used to detect that the first parcel has passed the sorting destination.

15. The parcel sorting system of claim 11, wherein the location proximate to the first parcel is a location above, below, or otherwise directly associated with the movement of the first parcel on the conveying surface, and the corresponding sorting instruction is scrolled across the scrolling marquee display at substantially a same speed that the first parcel is conveyed on the conveying surface so that the corresponding sorting instruction remains proximate to the first parcel.

16. The parcel sorting system of claim 15, further comprising an encoder used to determine the speed that the first parcel is conveyed on the conveying surface.

17. The parcel sorting system of claim 15, further comprising a plurality of sensors to determine the speed that the first parcel is conveyed on the conveying surface.

18. The parcel sorting system of claim 11, wherein the scrolling marquee display is a pixel-based marquee display.

19. The parcel sorting system of claim 11, wherein the scrolling marquee display comprises a plurality of individual display units.

20. The parcel sorting system of claim 11, wherein receiving sorting information of the first parcel includes using a reader to detect indicia on the first parcel and performing an optical character recognition process or a barcode recognition process on the indicia.
